(19) United States
(12) Patent Application Publication
(10) Pub. No.: US 2025/0162103 A1
(43) Pub. Date: May 22, 2025

(54) WATER POWERED ROTARY TOOL

(71) Applicant: La Plata Industries, Inc., Oakland Park, FL (US)

(72) Inventor: Marcelo Didone, Oakland Park, FL (US)

(73) Assignee: La Plata Industries, Inc., Oakland Park, FL (US)

(21) Appl. No.: 18/838,984

(22) PCT Filed: Feb. 16, 2023
(86) PCT No.: PCT/US2023/013258

§ 371 Date: Aug. 15, 2024

Related U.S. Application Data
(60) Provisional application No. 63/268,073, filed on Feb. 16, 2022.

(51) Int. Cl. B24B 47/14; A47L 7/00; B24B 7/18; B24B 27/08

(52) U.S. Cl. CPC B24B 47/14; A47L 7/0095; B24B 7/186; B24B 27/08

(57) ABSTRACT

Described is a high-pressure water-powered rotary tool in a horizontal orientation used for polishing, wet-polishing, grinding, polishing, a surface or in a vertical orientation for cutting a hard material.

### FIELD OF THE INVENTION

The present invention concerns high-pressure water-powered or water-driven tools. More specifically, the present invention relates to a high-pressure water-powered rotary tool which can be configured to employ a horizontally oriented grit pad or grinding cup, useful for polishing or grinding (roughing) a hard surface,, such as wet-polishing a stone or cement wall or flooring surface The high-pressure water-powered rotary tool of the invention can also be configured to employ a vertically oriented cutting disk or “saw blade,” useful for cutting through a hard material such as stone, cement, metal, or the like.

### BACKGROUND

Throughout industry and within the home, a need exists for tools that can be safely used for wet polishing within wet environments. This is particularly true of areas in and around swimming pools where a high risk of electrical shock exists with the utilization of conventional power tools operated by electricity.

Water driven rotational tools are known. For example, U.S. Pat. Nos. 7,357,701 and 7,500,907 describe rotary tools that includes a rigid metal housing, a high pressure water inlet, an impeller rotatably mounted within the housing, a single output drive shaft connected to the impeller, a backing disk connected to the drive shaft, and a handgrip or extendable handle capable of articulation throughout an extended range.

The previously described rotary tools are attachable to a pump driven by an electric motor or internal combustion engine. However, neither describes a rotary tool having a separate drive shaft and disk shaft, wherein the drive shaft and disc shaft are offset from one another, and which engage and work together to provide mechanical and other advantages realized by the invention described herein.

### SUMMARY OF THE INVENTION

The present invention concerns a rotary tool powered or driven by pressurized water. A water-powered rotary tool of the invention can include a body comprising a housing having a water inlet conduit and a water exhaust aperture. The housing bounds a cavity through which pressurized water flows to drive an impeller, integrated with rotating shafts and various tool attachments, such as polishing, grinding, or cutting attachments, for operation of the rotary tool. A high-pressure water source can be connected to the rotary tool by a delivery hose having a fitting adapted for connection with a water inlet conduit formed within the housing, delivering highly pressurized water flow through the cavity, whereby the highly pressurized flowing water is then expelled from the cavity, exiting the housing through a water exhaust aperture.

Disposed within the housing cavity and between the water inlet conduit and water exhaust aperture is an impeller. The impeller includes a plurality of vanes and is capable of rotating when contacted by the flowing water. The impeller's rotation is preferably in the same direction as, or parallel to, the flow of water. The water inlet conduit can include a water inlet nozzle having a bore for directing flowing water onto the vanes of the impeller. The diameter of the bore can measure from 0.01 inches to 0.1 inches, preferably between and inclusive of about 0.055 inches to 0.06 inches, directing the pressurized water applied to the impeller vanes. The bore in the water inlet nozzle can result in the pressure of the water at the point of contact with the impeller, relative to the water pressure delivered from the high-pressure water source.

In one embodiment, the impeller is disposed between an upper base plate and a lower base plate which can position the impeller to optimally receive the flow of water onto the impeller vanes, thereby driving the impeller and, in turn, rotating shafts which are disposed within the rotary tool, namely a first shaft, termed a “rotating drive shaft” or “drive shaft,” and a second shaft, termed a “rotating disk shaft” or “disk shaft.”

The rotating drive shaft is affixed and mounted to the impeller so that it spins at the same rate as the impeller. This drive shaft is disposed completely within the housing cavity and has its long axis perpendicular to the rotational direction of the impeller.

Offset from, and parallel to, the drive shaft is a rotating disk shaft. The disk shaft includes a first end disposed within the housing cavity and a second end of sufficient length to extend externally, outside of the housing. The drive shaft and disk shaft are in communication with one another by a first and second gear, the first gear being affixed to the drive shaft and the second gear being affixed to the disk shaft. The first and second gears are positioned to engage one another when in operation.

The first gear is perpendicularly affixed or connected to the drive shaft. The second gear is perpendicularly affixed or connected to the disk shaft. Teeth on each of the respective first gear and second gear interlock and engage one another such that the water driven rotation of the impeller causes rotation of the drive shaft, turning the first gear affixed thereto, whereby the first gear engages the second gear affixed to the disc shaft, thereby turning the disc shaft and attachment, such as a backing disc, affixed at the second end of the disc shaft, outside the housing.

The first and second gear can be the same or different sizes but are preferably different sizes. In a preferred embodiment, the first gear has a smaller diameter than the second gear. A preferred size difference in the diameters of first gear and second gear is a ratio of about 1:2. First and second gears provided at these ratios can increase torque generated to a backing disc for polishing or wet-polishing a surface, compared to a rotary tool having a single drive shaft connected directly to the impeller and a backing disc connected to the single drive shaft.

In one embodiment, the housing includes an upper housing portion, a lower housing portion, and a middle housing portion disposed between the upper and lower housing portions. The middle housing portion is horizontally disposed below the impeller and above the first gear and second gear such that the cavity is partitioned into an upper chamber within the upper housing portion and a lower chamber within the lower housing portion. The middle housing portion can be useful to hold bearings which facilitate rotation of the gears and shafts. The middle housing portion can also be useful to serve as a barrier which prevents flowing water from transferring between the upper chamber, where water is permitted, and the lower chamber, where water is prevented from entering.

The upper housing portion comprises the inlet conduit and contains the impeller disposed within the upper chamber. Water from the pressurized water source can enter the upper chamber, but is directed to the water exhaust aperture without entering the lower chamber. The first gear and second gear are disposed within the lower chamber formed within the lower housing portion. This lower chamber is preferably maintained free of water and can be filled to contain grease, or another other hydrophobic substance, to prevent entry of water into the lower chamber to prevent binding and facilitate movement of the shafts and gears.

The second end of the disk shaft which extends externally from the bottom housing portion can include a backing disk connected thereto. Various polishing accessories can be interchangeably affixed to the backing disk. In a preferred embodiment, a polishing disc grit pad having an abrasive outer polishing surface can be affixed to the backing disk by hook-and-loop material matingly affixed to the inner surface of the grit pad and the outer surface of the backing disc. Such polishing or wet-polishing disc grit pads are well known in the art and can be selected according to the needed size and the type of surface intended to be polished using the rotary tool of the subject invention. Preferred polishing or wet-polishing disc grit pads comprise diamond.

In one embodiment, the housing has an outer surface comprising at least one port for receiving a handle. In a preferred embodiment, the outer surface of the housing is configured to integrally form a boss wherein a port is disposed to receive a detachable handle. Preferably the handle can be configured as a bar or tubular handgrip or other ergonomically designed handgrip for use with one hand. and to facilitate manipulation of the water-powered rotary tool with one hand of a user, while the user can utilize their other hand to operate a trigger handle to control the flow of pressurized water into the rotary tool. The handgrip can include a bushing or baffle comprising a vibration-absorbent material for reducing vibration in the handgrip and on to the user. The housing preferably comprises at least one port on a left side and at least one port on the right side for disposing the handgrip on either side to conveniently accommodate a right-handed or left-handed user. Alternatively, a port can be provided on a top face of the housing.

In an embodiment wherein the housing comprises a right-side port and a left-side port for attaching a handle or handgrip, a pair of extended handlebars can be attached to the right-side port and left-side port, the handlebars having sufficient length such that a user can operate the rotary tool from a standing position. Although it is conceivable and is within the scope of the invention described herein that a pair of extended handlebars can be affixed to only one side of the housing and configured so that a user can easily manipulate the rotary tool, a preferred embodiment comprises a pair of extended handlebars affixed to both a right-side port and the left-side port.

Any of the handgrip or handlebar configurations can include a hinged or pivoted connection, or include a universal joint for easy manipulation of the rotary tool by the user.

One embodiment of the present invention includes a housing having a valve or switch for controlling the flow of water into the water inlet conduit. In one configuration, the control switch can be configured as a hand-operated trigger employed for opening and closing the valve. The trigger can be configured as a trigger handle connected to and in-line with the pressurized water source, allowing for partial or full on/off control of the pressurized water entering the inlet conduit of the housing. In an embodiment comprising a single handgrip attached to the housing, the trigger handle can be used by the other hand of the user to direct and manipulate movement of the rotary tool.

The present invention further concerns a system comprising the described water-powered rotary tool and a high-pressure water source configured to deliver highly pressurized water into the rotary tool cavity via the water inlet conduit.

Preferably, a system of the invention can also include a vacuum attachment which engages and affixes to the edges and bottom portion of the rotary tool housing to minimize and prevent water from spraying or spilling into a surrounding indoor environment. The vacuum attachment can be advantageous for using the water-powered rotary tool in an indoor environment. The vacuum attachment comprises a skirting portion forming a barrier around at least a portion of the periphery of the vacuum attachment. The vacuum attachment also comprises a vacuum port capable of receiving a vacuum suction hose for collecting water which exits the water exhaust aperture of the rotary tool, further minimizing or preventing water from spraying or spilling into a surrounding indoor environment. The vacuum suction hose connects the vacuum port and vacuum transferring water or sludge collected in the vacuum attachment as a result of using the water-powered rotary tool, to a collection reservoir used in connection with the vacuum for collecting and storing the used water and sludge. Preferably the vacuum reservoir can automatically empty to a larger reservoir or outside environment during the process in view of the large volumes of water used when operating the rotary tool of the invention.

The present invention includes a method of wet-polishing a surface using an embodiment of a water-powered rotary tool of the invention. A method of the invention comprises the steps of:
a) providing a water-powered rotary tool as described herein, comprising a backing disk, and being configured for polishing a horizontal surface;
b) affixing a polishing or wet-polishing accessory to the backing disk of the water-powered rotary tool;
c) connecting a high-pressure water source to a water inlet conduit provided in the rotary tool housing; and
d) operating the water-powered rotary tool to polish a horizontal surface.

A method according to the invention can also be applied to polishing or wet-polishing an indoor surface, such as a cement floor, using a water-powered rotary tool as described. The method can comprise the steps of:
a) providing the water-powered rotary tool system as described herein, comprising a backing disk, and configured for polishing a horizontal surface, wherein the system further comprises a vacuum attachment as described;
b) affixing a polishing or wet-polishing accessory to the backing disk;
c) attaching a vacuum to the vacuum attachment by connecting the vacuum suction hose to the vacuum port;
d) connecting the high-pressure water source to the water inlet conduit provided in the rotary tool housing; and
e) operating the water-powered rotary tool to polish or wet-polish an indoor surface with minimal spilling into a surrounding indoor environment of water and sludge resulting from the use of the water-powered rotary tool.

In the embodiments described above, the rotary tool of the invention is configured to provide the rotating disk in a substantially horizontal plane, e.g., a floor, when in use. For ease of reference, this embodiment is termed a “horizontal orientation” embodiment of the rotary tool. In another embodiment of the rotary tool according to the invention, the axis of the housing and shafts disposed therein are oriented 90° from the horizontal plane, such that the rotating disk is vertically oriented when in use (herein, the “vertical orientation” embodiment.) The vertical orientation embodiment of the rotary tool of the invention can preferably be fitted with a disk in the form of a circular cutting disk, or “saw blade” which can be useful for cutting through a hard material such as stone, concrete, metal, and the like. As used herein, “cutting disk” and “saw blade” are equivalent terms and can be used interchangeably. A preferred cutting disk is a diamond-tipped or diamond-edged saw blade.

In a vertical orientation embodiment of the rotary tool of the invention, the housing and attachment features are substantially the same as in the horizontal orientation embodiment, but are adapted for use with a vertically oriented cutting disk. For example, the handgrip port can be provided such that the handgrip can be affixed onto a side or top face of the housing. Placement and positions of fittings and apertures for affixing or mounting attachments, such as a handlebar attachment or vacuum attachment and associated skirting, can also be adapted for the vertical orientation embodiment of the rotary tool.

A system of the invention can include a vertically oriented embodiment of the rotary tool, vacuum attachment, and vacuum, interconnected for use in cutting a hard surface using a cutting disk.

A method of the invention can therefore comprise the steps of:
a) providing a vertical oriented embodiment of a water-powered rotary tool as described herein, comprising a vertically oriented cutting disk;
b) connecting a high-pressure water source to a water inlet conduit provided in the rotary tool housing; and
c) operating the water-powered rotary tool to cut a hard material.

The above method employing the vertical oriented embodiment of a water-powered rotary tool can further comprise the step of attaching a vacuum to the vacuum attachment by connecting the vacuum suction hose to the vacuum port;

Other objectives and advantages of the present invention are, or will become apparent from the description herein, taken in conjunction with the accompanying drawings setting forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

The features and advantages of the invention will be readily understood by reference to specific embodiments which are illustrated in the appended drawings. These drawings depict only typical embodiments of the invention and are not considered as limiting the scope of the invention.

FIG. 1 is a perspective view of a water-powered rotary tool in accordance with a horizontal orientation embodiment of the subject invention;

FIG. 2 is an exploded perspective view of a water-powered rotary tool in accordance with a horizontal orientation embodiment of the subject invention, illustrating certain inner components of the rotary tool;

FIG. 3 is a cross-sectional side view of a water-powered rotary tool in accordance with a horizontal orientation embodiment of the subject invention, illustrating certain inner components of the rotary tool;

FIG. 4 is a cross-sectional side view of a water-powered rotary tool in accordance with a horizontal orientation embodiment of the subject invention, illustrating a nozzle provided in the rotary tool;

FIG. 5 is a front view of a system comprising a water-powered rotary tool system in accordance with a horizontal orientation embodiment of the subject invention, illustrating components and configurations of the system;

FIG. 6 is a perspective view of the vacuum attachment useful with a water-powered rotary tool in accordance with a horizontal orientation embodiment of the subject invention;

FIG. 7 is a perspective view of the vacuum attachment in accordance with a horizontal orientation embodiment of the subject invention, viewed from a side opposite the side viewed in FIG. 6, showing an access door provided in a sidewall of the vacuum attachment;

FIG. 8 is a front perspective view of a water-powered rotary tool in accordance with a horizontal orientation embodiment of the subject invention, comprising a vacuum attachment and a grinder cup tool, configured for grinding or roughing a hard surface;

FIG. 9 is an exploded, rear perspective view of the horizontal orientation embodiment of the water-powered rotary tool shown in FIG. 8;

FIG. 10 is a front perspective view of a water-powered rotary tool in accordance with a vertical orientation embodiment of the subject invention, configured for use with a cutting disk or saw blade for cutting a hard material;

FIG. 11 is an exploded rear perspective view of the vertical oriented embodiment of the water-powered rotary tool of the invention as illustrated in FIG. 10;

FIG. 12 is the embodiment shown in FIG. 11, as assembled.

FIG. 13A is section view of a vertical orientation embodiment of the rotary tool of the invention, illustrating a window or cut-out area provided to facilitate access by the user to the disk shaft for affixing and detaching a cutting blade or disk;

FIG. 13B is a perspective view of the section view shown in FIG. 13A, illustrating access to the disk shaft with a wrench;

FIG. 14 is a side perspective view of a vertical orientation embodiment of the rotary tool of the invention, illustrating its connection to a trigger handle for providing pressurized water to the rotary tool, and further illustrating the positioning of the cutting disk or saw blade for use;

FIG. 15 is a perspective view of a system of the invention comprising the vertical oriented embodiment of the rotary tool, the water source trigger handle, and the vacuum source with collection reservoir.

### DETAILED DESCRIPTION

The preferred embodiments of the present invention can be understood by the description and the accompanying drawings provided herein. It will be readily understood that the components of the present invention can be arranged in a variety of different configurations. Thus, the following detailed description, and representations provided in the drawings, is intended to describe, and exemplify the preferred embodiments of the invention, and is not intended to limit the scope of the invention as claimed.

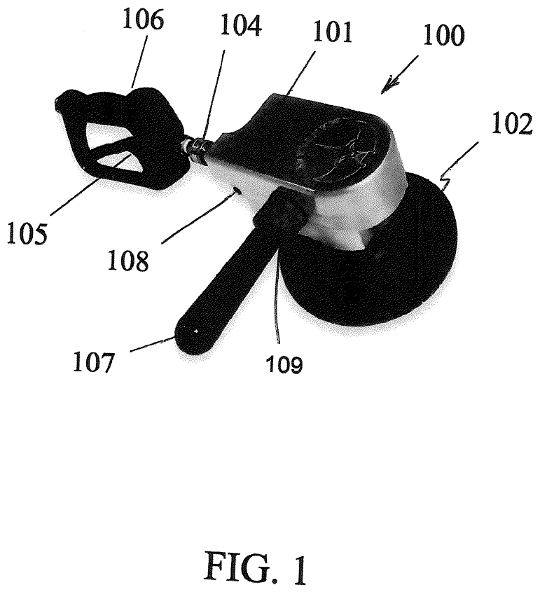

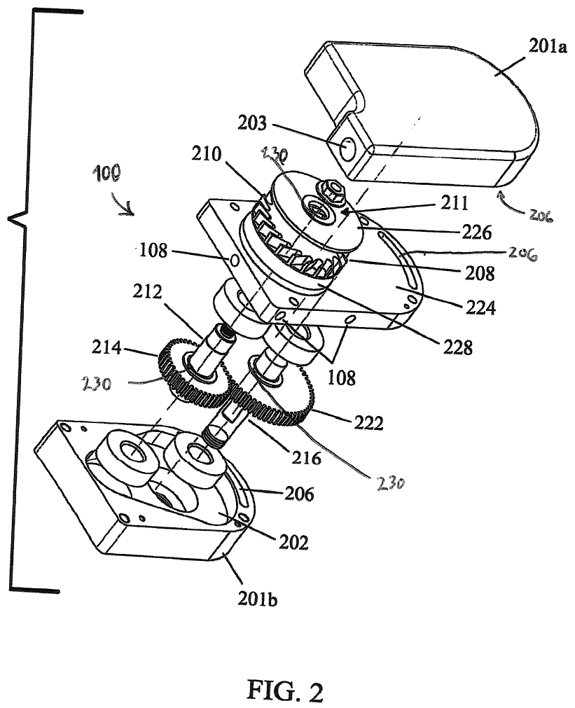

Referring to the drawings, FIG. 1 shows a perspective view of a hand-held embodiment of a water-powered rotary tool 100 according to the invention, illustrating the externally visible components of the tool. Specifically, FIG. 1 illustrates the housing 101 which encloses the inner workings of the tool as described and shown in the specification, including the accompanying drawings. The inner workings of the tool are driven by water pressure supplied to the tool via a connector 104 connecting a pressurized water source to the rotary tool at a rearward end of the housing. Housing 101 includes inlet port 203, as illustrated in FIG. 2, for receiving the connector 104.

The flow of water into inlet port 203 can be controlled or regulated by the user using a flow regulator or valve and can employ a hand actuated trigger assembly 105 attached upstream to the water inlet connector 104. Hand actuated trigger assembly can be configured to include a trigger handle 106 to facilitate operation of the trigger assembly 105. The valve actuating trigger 105 may be actuated or squeezed with a person's hand to allow the water to be turned on and off to the device. The water inlet connector 104 can be threadably coupled directly to the water inlet 203 or alternatively, a second flexible member can be utilized in conjunction with the trigger handle. FIG. 1 shows one embodiment of a trigger handle comprising a valve actuating trigger 105 integrated within a trigger handle frame 106. This integrated handle and trigger configuration can advantageously facilitate a user's manipulation of the trigger and directional control of the tool using one hand.

Housing 101 can also be configured to receive a handle disposed on a side of housing 101, whereby the side handle is configured as a guide handgrip 107, shown in FIG. 1 as being configured as a substantially straight and rigid bar. Guide handgrip 107 can be affixed to the housing on either a right side or left side of housing 101 by attaching the handle to an aperture 108 formed in the housing and configured to receive the handle in a detachably locking manner. For example, the handgrip 107 can be engaged with one of a plurality of receiving apertures 108, and engaged within the receiving apertures by mated threads, interlocking grooves, or the like to secure the guiding handgrip into the aperture and thereby secure the guiding handgrip to the housing. Guiding handgrip 107 can be used for operator manipulation of the water-powered rotary tool during operation. Guiding handgrip 107 can include a bushing or baffle 109 to reduce vibrations passing to the user from the rotary tool during operation. Preferably, baffle 109 is formed from a vibration-absorbing material such as rubber or plastic, but can be any material capable of performing a vibration-absorbing function.

The shape of the housing is not critical, but generally conforms to accommodate the configuration of the inner workings, which comprise at least two circular gears. Inner workings and operating components of the subject rotary tool are illustrated in FIG. 2. Accordingly, the outer shape of the housing is generally an oblong oval shape having generally rounded front or leading edge, and a rectangular following or rearward edge, wherein the rearward edge can include a bossing area for housing an inlet conduit connecting the inlet port with a chamber formed within the housing.

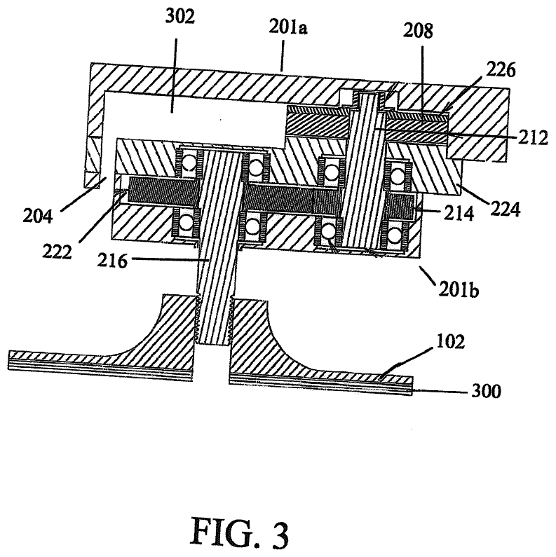

FIG. 2 shows an exploded view of the hand-held embodiment of the water-powered rotary tool 100, illustrating inlet port 203 where water is delivered into the housing. The water-powered rotary tool includes an upper housing portion 201a, forming an upper chamber 302 (illustrated in FIG. 3) therewithin, and a lower housing portion 201b forming lower chamber 202 therewithin, the upper chamber and lower chamber containing operating components, such as gears, bearings, impeller, and shafts, of the subject rotary tool. In a preferred embodiment, the housing can include middle housing portion 224 separating the upper and lower chambers bounded by the upper and lower housing portions.

Delivered water flows into the upper chamber within upper housing 201a to drive the operation of the tool. Water flowing into or entering inlet port 203 encounters impeller 208 comprising a plurality of vanes 210. Preferably, impeller 208 is disposed between an upper plate 226 and a lower base plate 228, which prevent water flowing into the housing from being directed vertically, in an up or down direction, and away from the impeller vanes 210. In a preferred embodiment, impeller 208 comprises vanes configured in a chevron shape, and having cusped edges for increased performance compared to vanes or blades that are not cusped, such as flat vanes, or vanes that are not chevron-shaped. In a most preferred embodiment, the impeller includes about 15-20 vanes, and preferably 19 vanes arranged around a perimeter edge of the impeller. A preferred size of an impeller used in a water-driven rotary tool in accordance with the subject invention is about 2 inches to about 3.5 inches, preferably about 2.725 inches, in diameter and about 0.2 inches to about 0.5 inches, preferably about 0.35 inches, in thickness. With the cover plates, the impeller assembly measures substantially the same in diameter, preferably about 2.725 inches in diameter, and is about 0.4 inches to about 0.5 inches, preferably about 0.45 inches, in thickness.

Impeller 208 comprises a centrally disposed bore 211 through which drive shaft 212 can be disposed. Drive shaft 212 defines an axis of rotation for the impeller. Drive shaft 212 extends through the impeller bore to engage the impeller, whereby driveshaft 212 and impeller 208 rotate together as engaged when the impeller is rotated by pressurized water flowing into the upper chamber.

Pressurized water flows past impeller 210 in the upper chamber of upper housing portion 201a and is directed via an exhaust aperture 206 (not visible in FIG. 2) in the upper housing portion toward a matingly configured exhaust aperture 206 formed in the middle housing portion 224 allowing water from the upper chamber to exit the housing without entering lower chamber 202, and directing the flowing pressurized water onto a backing disc and grit pad for wet-polishing of a surface. Lower housing portion 201b can include exhaust aperture 206 formed therein. Alternatively, the frontward-most wall of lower housing portion can be truncated, as illustrated in the embodiments shown in FIGS. 1, 3, and 4, whereby the frontward-most wall of lower housing portion 201b is closed to prevent water from entering lower chamber 202. In the embodiment whereby the frontward-most wall is truncated, water exiting the exhaust aperture 206 in middle housing portion 224 by passes the lower housing 201b altogether, allowing water to flow directly onto a backing disc. Exhaust aperture 206 is constructed and arranged to utilize centrifugal force to direct and exhaust the high-pressure water after it contacts the impeller 208 onto a backing disc. Impeller 208 is disposed within the housing cavity, positioned laterally between the water inlet conduit and the exhaust aperture. In a most preferred, but non-limiting embodiment, the high-pressure water contacts impeller vanes 208 at an angle of at least 45 degrees and preferably greater than 75 degrees, most preferably at an angle of about 90 degrees for optimal efficiency.

Drive shaft 212 includes a key-way system 230 for interlocking with parts connected perpendicular thereto. For example, a key-way 230 can align with outer key-way in the impeller aperture and lock-nut, and key-way interlocking systems are included to secure the gears 214 and 222 to their respective shafts 212 and 216. Drive shaft 212 also includes a threaded stem that engages the lock-nut to secure the impeller and the drive shaft together. In this manner, the impeller and the drive shaft rotate together, and the upper and lower impeller plates are prevented from separation.

Affixed perpendicular to drive shaft 212 is a first gear 214 having teeth on its peripheral edge. First gear 214 is positioned such that its peripheral teeth or cogs interlockingly engage or mesh with peripheral teeth or cogs of second gear 222. Second gear 222 is in turn perpendicularly affixed or connected to a disk shaft 216. Disk shaft 216 has sufficient length such that a lower portion of disk shaft 216 extends through an aperture located in a lower portion of the housing 201b, whereby disc shaft 216 extends outside the housing. The end of disc shaft 216 extending outside the housing is configured for attachment to a backing disc (not shown in FIG. 2). The lower portion of the disk shaft 216 extending outside the housing can include a threaded portion for attachment to the backing disk having mated threads configured to threadingly engage to the disc shaft.

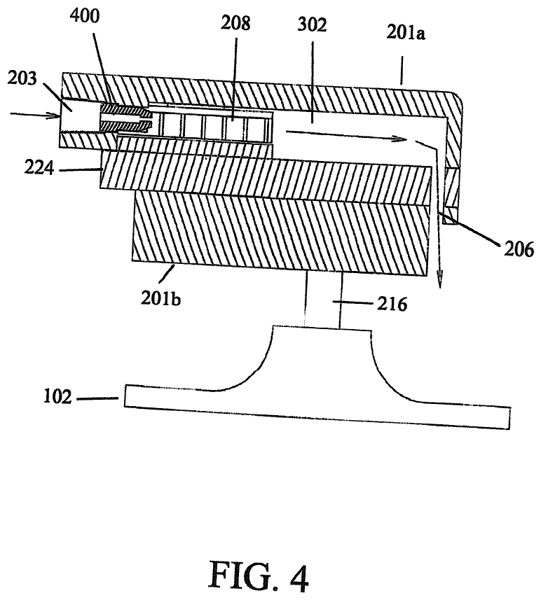

As illustrated in FIG. 2 (and in FIGS. 3 and 4), the first and second gear can be different sizes. In a preferred embodiment, the first gear has a smaller diameter than the second gear. A preferred size difference in the diameters of first gear: second gear is a ratio of about 1:1.5 to about 1:3, and more preferably about 1:2. First and second gears provided at these ratios can increase torque generated to a backing disc for polishing or wet-polishing surfaces, compared to a rotary tool having a single drive shaft and backing disc connected directly to the impeller. For example, in one preferred embodiment, a first gear is provided having a width ranging from about 1.5 inches to about 2 inches, preferably about 1.7 inches, in diameter, and has a thickness ranging from about 0.3 to about 0.5 inches, preferably about 0.38 inches; a second gear is provided having a width of about 3 inches to about 4 inches, and is preferably about 3.29 inches, in diameter, and from about 0.3 to about 0.5 inches, preferably about 0.375 inches in thickness.

As shown in cross-section in FIG. 3, backing disk 102 is constructed and arranged for attachment of a polishing accessory 300. A preferred polishing accessory is a grit pad having an abrasive outer polishing surface. Such polishing or wet-polishing disc grit pads are well known in the art and are commercially available in sizes which fit with the backing disc. The backing disc can range from about 3 inches to about 10 inches in diameter, and is preferably about 7 inches in diameter. The polishing or wet-polishing grit pad can be selected according to the needed size and the type of surface intended to be polished using the rotary tool of the subject invention. Preferred polishing or wet-polishing disc grit pads comprise diamond. The polishing or wet-polishing grit pad can be affixed to the backing disk by hook-and-loop material on the inner surface of the polishing or wet-polishing grit pad and the mated outer surface of the backing disc. Adhesive, and more specifically, removable adhesive, for affixing the polishing or wet-polishing disc grit pad to the backing disc is not preferred for use in a wet environment as intended in use of the subject rotary disc tool.

Rotation of the impeller 208 causes rotation of backing disk 102 and polishing accessory 300, e.g., a polishing or wet-polishing disc grit pad, affixed thereto, so that a user may employ the device for grinding, buffing, polishing, and the like. The backing disk can be affixed with a polishing accessory by hook and loop material, adhesive, snaps, or other means well known in the art for securing substantially flat surfaces to one another. In one embodiment, the polishing accessory is a polishing grit pad. In a preferred embodiment, the polishing accessory has an outer face comprising an abrasive polishing surface.

FIG. 4 is a cross-sectional side view of the instant invention showing the direction of water flow through the device. FIG. 4 shows water inlet nozzle 400 is positioned to control water flow and can increase water pressure prior to its engagement with impeller 208. Water inlet nozzle 400 comprises a bore for directing flowing water onto the vanes of the impeller at increased pressure from the already pressurized water delivered by the water source. The diameter of the bore can measure from 0.01 inches to 0.1 inches, preferably between and inclusive of about 0.055 inches to 0.06 inches, directing the pressurized water applied to the impeller vanes.

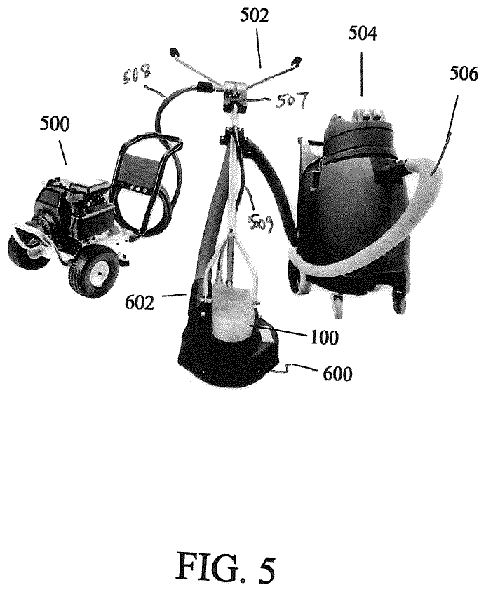

A water powered rotary tool 100 of the invention configured for operation by a user in a standing position, is illustrated in FIG. 5, wherein the water powered rotary tool 100 can be provided as a component of a system (referred to herein as the “upright rotary tool embodiment.”) The upright rotatory tool embodiment comprises, along with the rotary tool, itself:
a vacuum attachment component into which the rotary tool is seated,
a high-pressure water source component, and
a vacuum component.

A system of the subject invention can include the rotary tool with any one of the vacuum attachment, high-pressure water source, or vacuum components. A preferred embodiment of a system of the invention includes the rotary tool and vacuum attachment, which can be used in conjunction with a high-pressure water source and vacuum component separately obtained by a user. Another preferred embodiment of the system can include a rotary tool and vacuum attachment and at least one of the high-pressure water source or vacuum components.

Each of these components of the system work together to enable polishing or wet-polishing of an indoor surface, such as a floor, using large volumes of water, but without over-wetting or flooding the surrounding area. The housing of the rotary tool can receive into one or more of its apertures 108, an extended handle, or handlebar, preferably a pair of handlebars connecting to each side of the housing, to facilitate manipulation of the rotary tool from a standing position. In a preferred embodiment, a pair of handlebars, can be engaged to tow ports formed on opposing sides of the rotary tool housing.

As further illustrated in FIG. 5, the extended handlebar 502 can include a universal joint which allows the handle to be articulated through a large range. The extended handlebar 502 may also include a telescoping section (not shown), well known in the art for varying the length of the extended handle 502. The handlebar 502 can also include a fitting block 507 into which a pressurized water source tube 508 and rotary tool delivery tube 509 connecting to the delivery port in the housing. The handlebar 502 be attached to at least one aperture 108, and preferably two apertures 108, provided in the housing, wherein one of said two apertures 108 is formed on one side of the housing and the other of the two apertures 108 is formed on the other side of the housing.

The water source can be provided under normal pressure, such as water from a household spigot connected to the rotary tool using a conventional garden hose or, more preferably, a high-pressure water source 500. High-pressure water sources are well known in the art and may create pressurized water delivery using an internal combustion engine or electric motor. Water source tube 508 is preferably a flexible hose connecting the water source to the water inlet connector, either directly, or indirectly by way of a rotary tool delivery tube 509, provided on the rotary tool to deliver pressurized water to the rotary tool of the invention.

FIG. 5 also illustrates the vacuum and collection reservoir (together, hereinafter referred to as the “vacuum component” 504) included as part of the upright rotary tool system Vacuum component 504 can preferably be an industrial vacuum. Various sizes of industrial vacuums are commercially available which produce varying levels of vacuum pull or suction strength. A preferred industrial vacuum used in a system of the subject invention is a two-motor industrial vacuum. An industrial vacuum useful in a system of the invention preferably includes a reservoir that can automatically empty to a larger reservoir or outside environment during the process in view of the large volumes of water used when operating the rotary tool of the invention.

The vacuum component 504 is connectable to the vacuum attachment component via a vacuum hose 506 for receiving and transferring water and dirt or sludge collected within the vacuum attachment to the vacuum collection reservoir for storing the water and sludge that results from the use of the water-powered rotary tool.

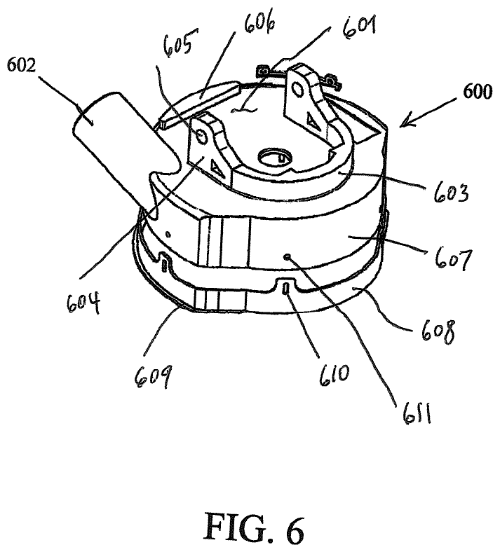

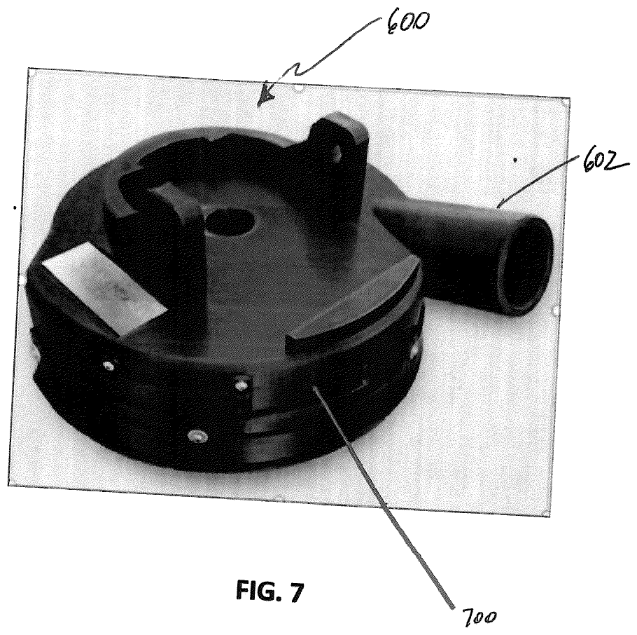

Vacuum attachment 600 is illustrated in more detail in FIGS. 6 and 7. Referring to FIG. 6, vacuum attachment 600 comprises a top face having a recessed area 601 configured to matingly receive and seat the rotary tool, and has one or more peripheral side wall 607 extending downward from the top face to form a lower edge of the side wall 607. Vacuum attachment sidewall 607 forms a chamber within the vacuum attachment wherein the disc shaft, backing disc and rotary disc grit pad can operate freely without impedance. Sidewall or sidewalls can have a height such that at least a portion of the sidewall 607, and preferably the entire sidewall 607 is generally level with the polishing surface of the rotary disc grit pad when the backing disc and grit pad are in operational position and contacts the floor when in use.

In a preferred embodiment, side wall 607 extends only part of the distance to the floor and can include an annular skirt 608, which is adjustable in relation to the side wall 607, allowing for different thicknesses of backing disc and grit pads to be used with the vacuum attachment. Adjustable skirt 608, is separable from and connectable to sidewall 607, forming a bottom edge of the sidewall. Adjustable skirt 608 preferably comprises one or more slotted connection holes 610 for receiving a securing screw or pins, which matingly engage with one or more screw or pin holes 611 formed in the sidewall or sidewalls. Slotted holes 610 provided in adjustable skirt 608 allows for the bottom edge of the sidewall to have an adjustable height to accommodate variable thicknesses of the polishing grit pad and to position the bottom edge of the sidewall or skirt as close to the floor as possible when the rotary tool is in operation.

The. Preferably the side walls of the vacuum attachment are configured to allow the rotary tool to polish an area less than two inches (2 in.) from an upright wall perpendicular to the floor area being polished. More preferably, the vacuum attachment is configured to allow polishing within about 0.1 inches to about 0.5 inches from an upright wall. A preferred embodiment provides for polishing or wet polishing a floor area within about 0.19 inches from an adjacent upright wall.

The vacuum attachment further comprises a vacuum port 602 for affixing the vacuum suction hose thereto, for collecting and carrying away from the polishing area a majority of the volume of water used in the operation of the rotary tool. The vacuum port is generally tubular, forming an exhaust aperture to carry away water used in the operation of the rotary tool. The outer diameter of the tubular vacuum port can be sized to tightly engage the vacuum suction hose connected to the vacuum, and has an inner diameter to accommodate easy and rapid removal of the water and any dirt or sludge generated by use of the rotary tool, preferably having an inner diameter of about one-half inch, three-quarter inches, about one inch, about one and one-half inches, or about two inches.

FIG. 6 shows a vacuum attachment 600 having a recessed area 601 on a top face of the vacuum attachment configured to receive and seat the rotary tool of the invention as described. The rotary tool can be secured to the vacuum attachment by connecting the rotary tool to one or more apertures 605 which can receive a retaining strap, retaining pin, bolt, screw, or the like. to affix the rotary tool and vacuum attachment together. Preferably, the vacuum attachment also includes on a top face a retaining barrier 603 configured to matingly engaging a curved front area of the rotary tool housing, for maintaining position and orientation of the rotary tool in relation to the vacuum attachment when in use. Retaining barrier 603 can be integral with or adjoined to an upright retention flange 604 comprising the apertures 605, further stabilizing and securing the rotary tool to the vacuum attachment.

In the embodiment shown, the vacuum attachment can further comprise a retaining platform 606, which functions to engage a back face of the housing, further maintaining the position and orientation of the rotary tool when seated onto the vacuum attachment. Through the vacuum port 602, the vacuum attachment 600 can therefore facilitate suctioning of water and dirt or sludge resulting from operation of the water-powered rotary tool in an indoor environment.

The vacuum attachment can comprise a flanged peripheral sidewall or sidewalls which serve to prevent spraying of effluent from the tool to the surrounding environment, thereby permitting use of the rotary tool indoors, e.g., for rotary polishing of an indoor flooring surface.

A further feature of adjustable skirt 608 is lip 609, which is provided on at least a portion of bottom edge of skirt 608, and is preferably formed on a back portion of the bottom edge. Preferably, lip 611 is formed on a portion of the peripheral edge, about 150 degrees to about 240 degrees around its perimeter, and more preferably about 180-degrees (about half-way) around the bottom peripheral edge of skirt 608. Primarily, lip 611 can provide stability of the rotary tool when operated by a user, preventing the vacuum attachment from tilting away from the floor. The lip 611 can further advantageously facilitate handling and movement of the rotary tool while in operation, block the exit of water from the vacuum attachment, and facilitate suctioning of effluent water through the vacuum port.

FIG. 7 shows a perspective view of vacuum attachment 600 also illustrated in FIG. 6, but from an opposing view, wherein the vacuum port 602 is oriented on a back side of the vacuum attachment. This view shows access door 700 provided in a sidewall of vacuum attachment 600. Access door 700 which is preferably provided as a sliding door which opens side-to-side, provides user access to the disc shaft for adjustment, connection, removal of the disc, backing disc, or rotary disc grit pad without disconnecting the rotary tool form the vacuum attachment. Preferably, access door 700 closes tightly, and substantially in a water-tight fashion to prevent loss of suction or permitting excess water to exit from the door when in use. However, access door 700 can further be useful for adjusting air flow and suction strength of the vacuum. For example, when an industrial vacuum having optimal suction strength is unavailable, such as a three-motor vacuum, suction strength may be greater than desired and impede the movement of the vacuum attachment in relation to the floor. By opening the access door partially or fully, the suction can be optimized for use of the rotary tool and vacuum attachment without undesired impedance.

In operation, high pressure water is received from the high-pressure water source 500 through the flexible hose member. Depression of the valve assembly trigger 105 allows the water to flow into inlet conduit 203 and the nozzle 400 to strike the impeller 208, wherein the high-pressure water impacts the impeller vanes 210 at an angle substantially perpendicular to the axis of rotation causing rotation of the impeller 208 and the drive shaft 212 which in turn rotates the backing disk 102. The water that is impacted against the impeller vanes 210 is centrifugally evacuated through the exhaust aperture 206 which directs the water outwardly and onto the backing disk 102 and grit pad for wet-polishing.

In the preferred embodiment, the components comprising the housing are formed of, but not limited to, a suitable metal material through the process of machining or precision casting. In a most preferred embodiment, the housing is formed of aluminum for minimum weight and corrosion resistance. In the preferred embodiment, the components comprising the impeller and drive shaft are formed of, but not limited to, a suitable metal material through the process of machining or precision casting. In a most preferred embodiment the impeller, the drive shaft, and the disk shaft are formed of stainless steel or other non-corrosive material, including aluminum. The result is that the components comprising the water-powered rotary tool are lightweight and corrosion resistant leaving the external surface in a generally smooth condition for aesthetic purposes.

In addition to the water-powered rotary tool device, the present invention is also directed to a system including the water-powered rotary tool and a source of high-pressure water 500 configured to dispense flowing water into the water inlet conduit 203.

In addition to the device and system, the present invention is also directed methods of wet-polishing a surface using the water-powered rotary tool. One method comprising the steps of:
a) providing a water-powered rotary tool;
b) affixing a polishing accessory to the backing disk of the water-powered rotary tool;
c) connecting a high-pressure water source to the water inlet conduit; and
d) operating the water-powered rotary tool to polish or wet-polish a surface.

A second method of the present invention is directed to wet-polishing an indoor surface using a water-powered rotary tool. The method comprising the steps of:
e) providing the water-powered rotary tool system and vacuum attachment as described;
f) affixing a polishing accessory to the backing disk;
g) attaching the vacuum to the vacuum attachment by connecting the vacuum suction hose to the vacuum port;
h) connecting the high-pressure water source to the water inlet conduit; and
i) operating the water-powered rotary tool to polish an indoor surface without spilling water and sludge resulting from the use of the water-powered rotary tool into a surrounding indoor environment.

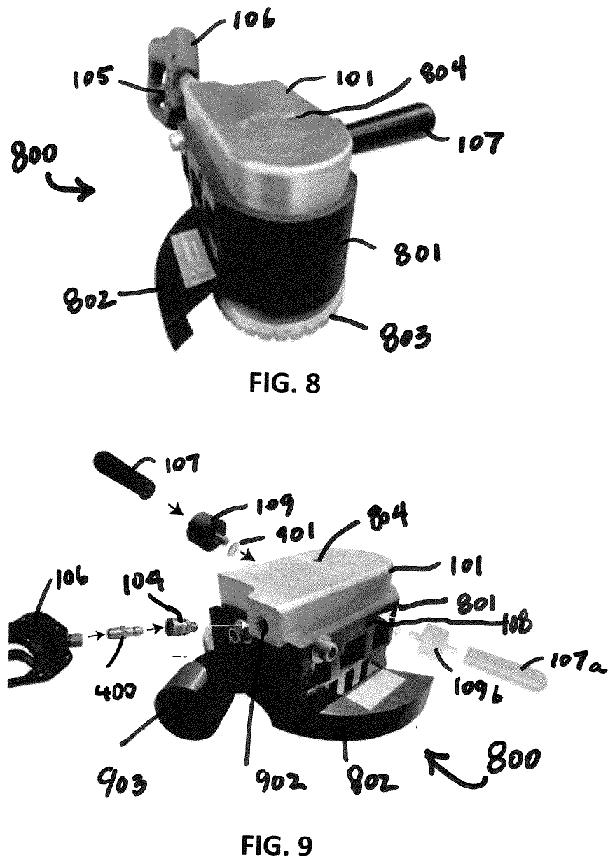

FIG. 8 shows a front perspective view of a hand-held horizontal oriented embodiment of a water-powered rotary tool 800 according to the invention, useful for grinding or roughing a flat surface of a hard material. FIG. 8 illustrates certain externally visible components of the tool. Certain elements remain identical to those of the embodiment shown in FIG. 1, namely, housing 101 which encloses the inner workings of the tool as described and shown in the specification. The inner workings of the tool are driven by water pressure supplied to the tool via a connector 104 (not shown) connecting a pressurized water source to the rotary tool at a rearward end of the housing.

The flow of water into the cavity of the housing can be controlled or regulated by the user using a flow regulator or valve and can employ a hand actuated trigger assembly 105 configured to include a trigger handle 106 to facilitate operation of the trigger assembly 105. The valve actuating trigger 105 may be actuated or squeezed with a user's hand to allow the water to be turned on and off to the device. Housing 101 can also be configured to receive a handle disposed on a side of housing 101, whereby the side handle is configured as a guide handgrip 107, which can be a substantially straight and rigid bar having a tapered radius along its length. Guide handgrip 107 can be affixed to the housing on either a right side or left side of housing 101 by attaching the handle to an aperture 108 formed in the housing and configured to receive the handle in a detachably locking manner. For example, the handgrip 107 can be engaged with one of a plurality of receiving apertures 108, and engaged within the receiving apertures by mated threads, interlocking grooves, or the like to secure the guiding handgrip into the aperture and thereby secure the guiding handgrip to the housing. Guiding handgrip 107 can be used for operator manipulation of the water-powered rotary tool during operation. Guiding handgrip 107 can include a bushing or baffle to reduce vibrations passing to the user from the rotary tool during operation. Preferably, the baffle is formed from a vibration-absorbing material such as rubber or plastic, but can be any material capable of performing a vibration-absorbing function.

Departing from the embodiment shown in FIG. 1, the embodiment shown in FIG. 8 can include a vacuum attachment 801 comprising disk guard 802, which can protect a user from debris and water spray resulting from contact of disk 803 with the surface to be ground or roughed. In FIG. 8, the disk is shown as a grinding cup attachment. Also included in this embodiment illustrated in FIG. 8 is aperture 804, which can receive handgrip 107 on the top face of the housing 101.

This embodiment of FIG. 8 is illustrated from a rear perspective (and exploded) view in FIG. 9. This view shows rotary tool housing 101 having vacuum attachment 801 engaged therewith, wherein vacuum attachment 801 includes disk guard 802. Handle 107 is affixed to the housing at aperture 804 (not shown) and includes a baffle 109 and washer 901 to facilitate securing the handgrip to the housing. Alternatively, handgrip 107a and 109b are shown in phantom (white) to alternatively be affixed to the housing at aperture 108.

FIG. 9 further illustrates water inlet connector 104 which can be threadably coupled directly to the water inlet 902. Nozzle 400 can be contained within water inlet connector 104, receiving highly pressurized water flow from a pressurized water source, that can be regulated by hand using trigger assembly 105 configured to include a trigger handle 106. Also visible in this view provided in FIG. 9 is vacuum port 903, connectable to a vacuum hose for suctioning excess water used for operating the subject rotary device.

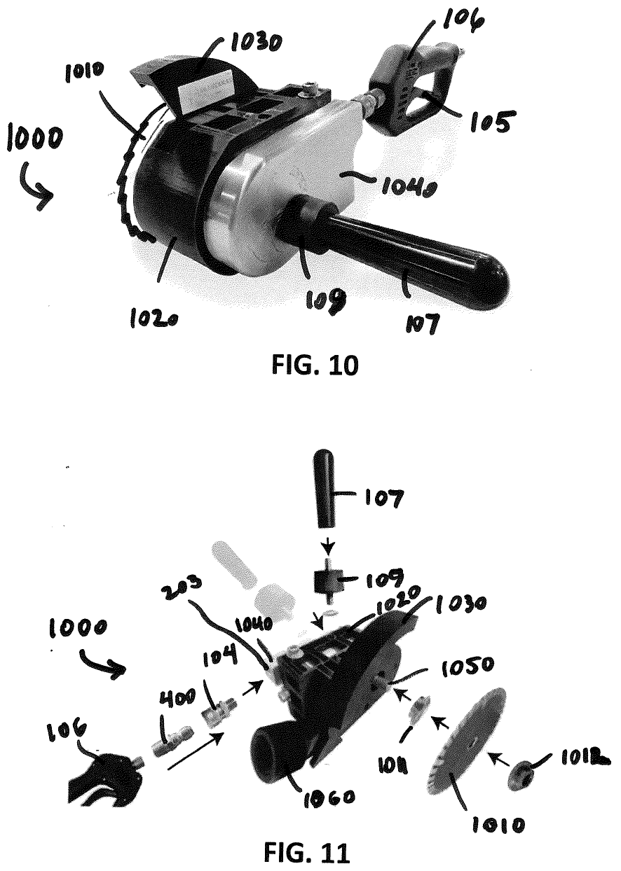

A vertical orientation embodiment 1000 of a rotary tool of the invention is shown in front perspective view in FIG. 10, and is configured for cutting a hard material. This vertical orientation embodiment comprises housing 1040 which is oriented 90° relative to the housing provided in the horizontal orientation embodiment described and shown herein. This vertical orientation embodiment further comprises vacuum attachment 1020 engaged with the housing 1040 and further provides disk guard 1030 protective of disk 1010, shown as a cutting disk or saw blade, in a vertical orientation. As in the horizontal orientation embodiment, the housing 1040 can include an aperture for receiving handgrip 107, threadably connected to the housing with baffle 109. At the rear of the housing 1040, inlet port (shown as 203 in other views) can receive water from a pressurized water source, regulated by trigger assembly 105 configured to include a trigger handle 106.

FIG. 11 is an exploded, rear perspective view of vertical orientation embodiment 1000 of the rotary tool of the invention. Shown in FIG. 11 are elements depicted in FIG. 10, including housing 1040 vacuum attachment 1020 engaged with the housing 1040, disk guard 1030 protective of disk 1010, shown as a cutting disk or saw blade, in a vertical orientation, handgrip 107, threadably connectable to the housing with baffle 109, inlet port 203, for receiving water through water inlet connector 104 comprising nozzle 400 contained therein, wherein the water can be delivered from a pressurized water source, and regulated by trigger assembly 105 configured to include a trigger handle 106. Also illustrated in FIG. 11 is disk shaft 1050 for connecting disk 1010 using bushing 1011 and nut connector 1012. At the rear of the vacuum assembly 1020 is vacuum port 1060, connectable to a vacuum hose for suctioning excess water used for operating the subject rotary device.

FIG. 12 shows vertical orientation embodiment 1000 of the rotary tool of the invention (as depicted in exploded view in FIG. 11) but in fully assembled configuration (and without cutting disk). Shown in FIG. 12, inter alia, are vacuum assembly 1020, disk guard 1030 and, at the rear of the vacuum assembly 1020 is vacuum port 1060. Attached to the rotary tool housing is handgrip 107, having a baffle 109.

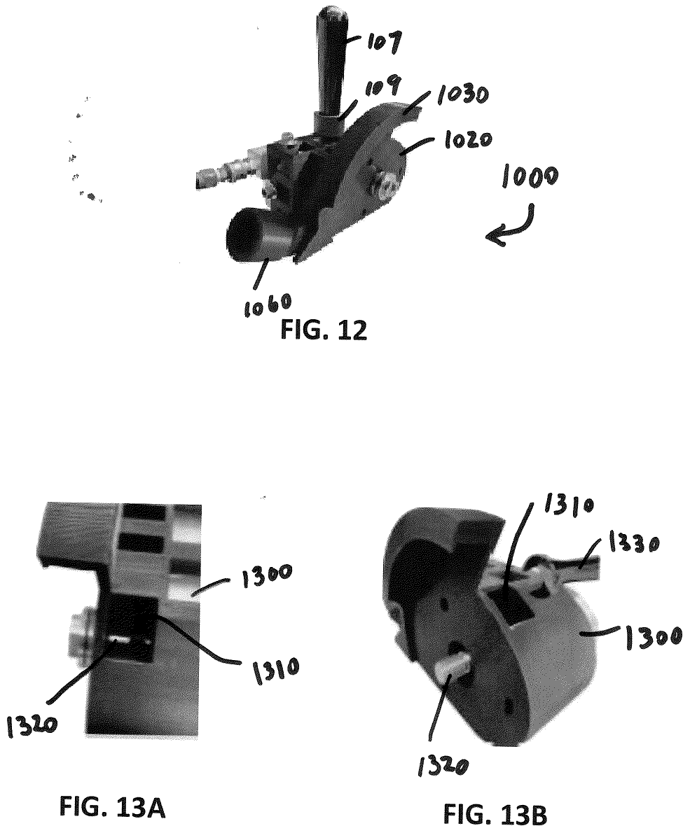

FIGS. 13A and 13B are provided to illustrate a configuration of vacuum assembly 1300, showing a cut-out area or window 1310 formed therein for accessing disk shaft 1320. FIG. 13A is a front view and FIG. 13B is a perspective view of vacuum assembly 1300. The access window 1310 is configured to be of adequate size to receive at least a ½-inch crescent wrench 1330 for tightening a disk (not shown), such as a cutting disk or saw blade, to disk shaft 1320.

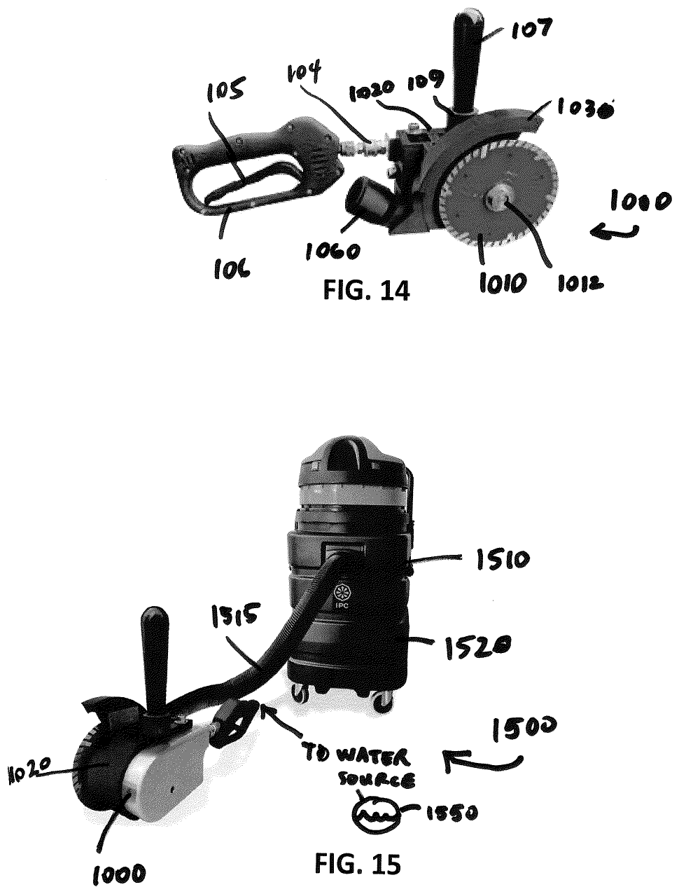

FIG. 14 is a right side view of a fully assembled vertical orientation embodiment 1000 of the rotary tool of the invention, illustrating vacuum attachment 1020, disk guard 1030 protective of disk 1010 affixed to a disk shaft by nut connector 1012, the disk shown as a cutting disk or saw blade, in a vertical orientation, handgrip 107, threadably connectable to the housing with baffle 109, water inlet connector 104 regulated by trigger assembly 105 and trigger handle 106, and vacuum port 1060.

Finally, FIG. 15 illustrates a system of the invention comprising vertical orientation embodiment 1000 of the rotary tool, connectable to a water source 1550, preferably a pressurized water source, such as a powered compressor, such as a powered pressure washer device, for delivery of pressurized water to the rotary tool. Vacuum 1510 is connected via vacuum hose 1515 to the vacuum port (not shown) at the rear of vacuum assembly 1020 for suctioning of excess water and sludge into a collection reservoir 1520, until the contents of the collection reservoir can be discarded.

Advantageously, the horizontal orientation embodiment and the vertical orientation embodiment of the rotary tool of the invention can substantially reduce dust created while cutting, polishing, or grinding hard materials, including but not limited to natural stone, porcelain, concrete, glass, metal, or tile. Preferred water pressures can range between a minimum of 2500 to a maximum of 4000 pounds per square inch (psi), delivering three to four gallons of water per minute. For cutting natural stone, concrete, and tile, a user can employ pressures of about 2500 psi to 3000 psi, and cutting metal can require at least 3000 psi. Grinding can employ higher psi settings, up to about 4000 psi. It is generally not preferred to exceed 4000 psi.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

The above disclosure and example generally describe the present invention and is provided for purposes of illustration and is not intended to limit the scope of the invention. The invention described herein may be practiced in the absence of any element or elements, limitation or limitations which is not specifically disclosed herein. Thus, for example, in each instance herein, any of the terms “comprising,” “consisting essentially of,” and “consisting of” may be replaced with either of the other two terms. The terms and expressions are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the claims.

What is claimed is:

1. A water-powered rotary tool comprising:
a housing bounding a cavity, said housing having a water inlet conduit for receiving flowing water from a high-pressure water source into the cavity, and a water exhaust aperture for expelling the flowing water from the cavity, and disposed within the housing cavity an impeller having a plurality of vanes, said impeller being disposed between the water inlet conduit and the water exhaust aperture and capable of rotating in a direction parallel to the flowing water when contacted thereby, said impeller being affixed to a rotating drive shaft mounted to the impeller, said rotating drive shaft being disposed within the housing and perpendicular to the orientation of said impeller, the drive shaft having a first gear perpendicularly affixed or connected thereto; and a rotating disk shaft offset from and parallel to said drive shaft, said disk shaft having a first end disposed within the housing cavity and a second end extending externally outside of the housing, wherein a second gear is perpendicularly affixed or connected to the disk shaft, said first gear and second gear interlockingly engaged to create torque such that rotation of the impeller causes rotation of the drive shaft and disc shaft; and a disk connected to the external second end of the disk shaft operable for polishing, grinding, or cutting.

2. The water-powered rotary tool of claim 1, wherein the housing further comprises an upper housing portion, a lower housing portion, and a middle housing portion horizontally disposed below the impeller and above the first gear and the second gear, said middle housing portion partitioning the cavity into an upper chamber within the upper housing portion and a lower chamber within the lower housing portion.

3. The water-powered rotary tool of claim 1 wherein the housing and disk are horizontally oriented for polishing or grinding a substantially horizontal surface of a hard material.

4. The water-powered rotary tool of claim 1 wherein the housing and disk are vertically oriented for cutting a hard material.

5. The water-powered rotary tool of claim 2, wherein the first and second gear are disposed within the lower housing portion and the middle housing portion prevents flowing water from entering the lower chamber.

6. The water-powered rotary tool of claim 3, wherein the disk shaft comprises at its second end, a backing disk for affixing thereto an accessory selected from a polishing accessory and a grinding accessory.

7. The water-powered rotary tool of claim 6, wherein the polishing accessory has an outer face comprising an abrasive polishing surface.

8. The water-powered rotary tool of claim 6, wherein the polishing accessory is a polishing grit pad.

9. The water-powered rotary tool of claim 1, wherein the housing has an outer surface comprising at least one port for receiving a handle.

10. The water-powered rotary tool of claim 1, wherein the impeller is disposed between an upper base plate and a lower base plate to direct water flow to the plurality of vanes of the impeller.

11. The water-powered rotary tool of claim 9, wherein the port for receiving a handle is disposed in a boss integrally formed on the outer surface of the housing.

12. The water-powered rotary tool of claim 9, wherein the handle received by the at least one port is a handgrip removably attached to the housing, and being configured to facilitate manipulation of the water-powered rotary tool by a user.

13. The water-powered rotary tool of claim 9, wherein the handle received by the at least one boss is an extended handle removably attached to the housing and being configured to facilitate manipulation of the water-powered rotary tool by a user.

14. The water-powered rotary tool of claim 12, wherein the extended handle includes a universal joint allowing for pivotal movement of said extended handle with respect to the housing.

15. The water-powered rotary tool of claim 1, wherein the water inlet conduit further comprises a water inlet nozzle having a bore, said bore configured to direct the flowing water onto the vanes of the impeller.

16. The water-powered rotary tool of claim 12, wherein the bore has a diameter measuring from about 0.01 inches to 0.1 inches.

17. The water-powered rotary tool of claim 12, wherein the bore has a diameter measuring from about 0.05 inches to 0.08 inches.

18. The water-powered rotary tool of claim 1, further comprising a valve for controlling flow of water into the water inlet conduit.

19. The water-powered rotary tool of claim 15, further comprising a hand-operated trigger operable to open and close the valve.

20. The water-powered rotary tool of claim 1, wherein the ratio of the diameter of the first gear and the second gear is about 1:2.

21. A water-powered rotary tool system, said system comprising:
a water-powered rotary tool of claim 1, and
a high-pressure water source configured to dispense flowing water into the water inlet conduit.

22. The water-powered rotary tool system of claim 21, further comprising a vacuum attachment configured to collect water exiting the water exhaust aperture and to prevent water from spilling into a surrounding indoor environment, said vacuum attachment having a vacuum port configured for receiving a vacuum suction hose connected to a vacuum having a collection reservoir for collecting water and sludge resulting from use of the water-powered rotary tool.

23. A method of wet-polishing a surface using a water-powered rotary tool, the method comprising the steps of:
providing a rotary tool of claim 1, and
affixing a polishing or grit pad accessory to the backing disk;
connecting a high-pressure water source to the water inlet conduit; and
operating the water-powered rotary tool to polish or wet-polish a surface.

24. A method of wet-polishing an indoor surface using a water-powered rotary tool, the method comprising the steps of:
providing a water-powered rotary tool of claims 17, affixing a polishing or grit pad accessory to the backing disk;
attaching the vacuum to the vacuum attachment by connecting the vacuum suction hose to the vacuum port;
connecting the high-pressure water source to the water inlet conduit; and
operating the water-powered rotary tool to scrub an indoor surface with minimal spilling of water and sludge resulting from use of the water-powered rotary tool into a surrounding indoor environment.

25. A method for cutting a hard material, said method comprising the steps of:
providing a vertical oriented embodiment of a water-powered rotary tool as described herein, comprising a vertically oriented cutting disk;
connecting a high-pressure water source to a water inlet conduit provided in the rotary tool housing; and
operating the water-powered rotary tool to cut a hard material.
